(19) United States
(12) Patent Application Publication
(10) Pub. No.: US 2020/0067174 A1
(43) Pub. Date: Feb. 27, 2020

(54) High Performance Antennas for Smart Appliances

(71) Applicant: AVX Antenna, Inc. d/b/a Ethertronics, Inc., San Diego, CA (US)

(72) Inventor: Chris Kennedy, Johns Creek, GA (US)

(21) Appl. No.: 16/444,255

(22) Filed: Jun. 18, 2019

Related U.S. Application Data
(60) Provisional application No. 62/720,556, filed on Aug. 21, 2018.

(51) Int. Cl. H01Q 1/22; G01N 25/56

(52) U.S. Cl. CPC H01Q 1/2291; G01N 25/56

(57) ABSTRACT

High performance antennas for smart appliances are described herein. An antenna for use with a smart controller for an appliance can include a length of memory metal. The antenna can be configured to maintain the length while undisturbed, deform while under external stress, and return to or near to the length after deformation. Additionally, one end of the length of memory metal is in operative communication with a communication circuit associated with the smart controller.

### PRIORITY CLAIM

The present application claims the benefit of priority of U.S. Provisional Application Ser. No. 62/720,556, filed on Aug. 21, 2018, titled “High Performance Antennas for Smart Appliances,” which is incorporated herein by reference.

### FIELD

The present subject matter relates generally to antennas.

### BACKGROUND

Antennas can be used to allow devices to communicate wirelessly with other remote devices. With the advance of Internet of Things technology, more and more devices, such as appliances, are being provided with the capability of wireless communication over, for instance, a network. In some cases, communication systems associated with, for instance, appliances may be located in a variety of environments depending upon particular use-cases. For example, water heaters can be located environments such basements, near easements, or in other unsheltered or non-environmentally controlled locations.

### SUMMARY

Aspects and advantages of embodiments of the present disclosure will be set forth in part in the following description, or may be learned from the description, or may be learned through practice of the embodiments.

According to one example aspect of the present disclosure, an antenna for use with a smart controller for an appliance can include a length of memory metal. The antenna can be configured to maintain the length while undisturbed, deform while under external stress, and return to or near to the length after deformation. One end of the length of memory metal can be in operative communication with a communication circuit associated with the smart controller.

According to another example aspect of the present disclosure, a smart appliance controller associated with a water heating appliance can include one or more processors, one or more memory devices, a communication circuit, and an antenna in operative communication with the communication circuit. The antenna can include a length of memory metal, the memory metal comprising an alloy of alloy of titanium and nickel.

According to another example aspect of the present disclosure, an antenna for use with a smart controller for a water heating appliance can include a length of memory metal. The length of memory metal can include an alloy of titanium and nickel. The antenna is configured to be placed operative communication with a communication circuit associated with the smart controller.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a schematic of a communication system with a high performance antenna according to example embodiments of the present disclosure;

FIGS. 2A, 2B, 2C, and 2D illustrate aspects of a controller associated with an antenna according to example embodiments of the present disclosure;

FIG. 3 depicts an example computer apparatus configured to provide for networking and/or control of an appliance with an antenna according to example embodiments of the present disclosure.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

Antennas are described herein for use with communication systems associated with, for instance, appliances, such as smart appliances, such as smart water heaters. As used herein, the use of the term “smart” refers to a system that has the capability of performing computing operations and communicating with one or more remote systems (e.g., via a wireless network using an antenna). According to example embodiments, of the present disclosure, an antenna can include a length of memory metal that is configured for use in a variety of environments. The memory metal may be robust and deformable while under external stresses, such as during installation. The memory metal may also return to an original form or shape after deformation (e.g., to within 90% of its original form or shape). This deformation and reformation can be useful when installation in cramped environments or where there are external stresses such as a technician walk-by, bumping, or similar activities.

In some embodiments, the antenna can be configured to maintain a first length or shape while undisturbed, deform to a different length or shape while under external stress, and return to or nearly to the first length or shape after deformation. As used herein, return nearly to the first length or shape indicates that the length or shape returns to within 90% of its original length or shape.

The antenna may also be installed in such a manner as to be proximate to a smart appliance controller for transmitting data. In this regard, at least one end of the memory metal of the high performance antenna can be in operative electrical communication with the smart appliance controller.

The smart appliance controller may be arranged proximate an appliance, such as a water heater. The water heater may be any suitable water heater, including a smart appliance having a dedicated controller, or a more traditional water heater requiring an external smart appliance controller. The antenna according to example embodiments of the present disclosure can provide good performance despite being located next to a large metal volume containing water.

Upon installation, the antenna may facilitate communication of data to and from the controller. The data may include data related to water temperature, energy consumption, peak wattage, peak current, overcurrent, and other similar data. Furthermore, the antenna may be configured to receive data related to control the water heater. For example, the antenna may receive data related to desired temperature settings, schedules, and other suitable data. Thereafter, the smart appliance controller may alter the operation of the water heater based on this data.

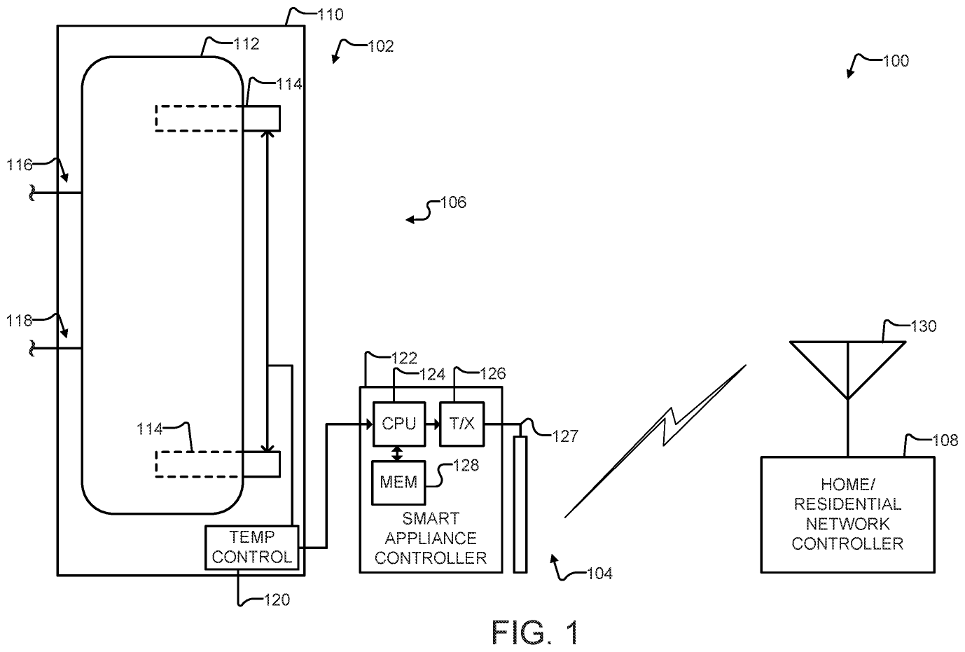

Turning now to the Figures, various examples of an antenna for use with a smart controller for an appliance, such as a water heater, are illustrated and described in detail. FIG. 1 illustrates a schematic of a system 100 including a smart appliance such as a water heater 102 with an antenna 104, in accordance with aspects of the present subject matter. Additionally, the antenna 104 may be configured for use with the water heater 102. Finally, the antenna may be configured to transmit and receive data related to the water heater 102 to network controller 108.

The water heater 102 can include a housing 110 formed of metal, such as sheet metal. The housing 110 may also be formed of other materials, such as composites or plastics. The housing 110 may also include a tank 112 configured to be heated by one or more heating elements 114. The tank 112 may be formed of a heat-resistant material, such as a metal or composite material. Although not explicitly shown, the tank 112 may be fixedly mounted within the housing 110 to limit vertical or horizontal motion relative thereto. The tank 112 may also be configured to receive water from inlet 116, heat the received water, and output heated water through outlet 118.

The heating of the received water may be controlled with temperature controller 120. Generally, temperature controller 120 may be in operative communication with the one or more heating elements 114. Accordingly, temperature controller 120 may direct the one or more heating elements 114 to energize and heat water within the tank 112. As further illustrated, the temperature controller 120 may be in operative communication with a smart appliance controller 106.

The smart appliance controller 106 may be any suitable controller, and may include a housing 122, a CPU or controller 124, a communication circuit 126 (e.g., receiver, transmitter, and/or transceiver), and memory 128. The housing 122 may include any suitable housing, including a rugged housing formed of metal or composite materials. The controller 124 may be a general or special purpose controlling component, such as one or more processors configured to execute instructions stored or received from memory 128 and/or communication circuit 126. The controller 124 may also communicate with the temperature controller 120 to send and receive data related to the water heater 102.

As shown, the antenna 104 may be in operative electrical communication with the communication circuit 126 over transmission line 127. It is noted that in some embodiments, the controller 106, and therefore the communication circuit 126, may be integrated with the water heater 102. The antenna 104 may transmit and receive data from the network controller 108 over a wireless communication protocol. This communication protocol may be facilitated by a communication circuit 130 of the network controller 108. Although several wireless communication protocols exist, example embodiments are not limited to a particular wireless communication protocol. Accordingly, exhaustive description of various wireless communication protocols are omitted herein for the sake of brevity.

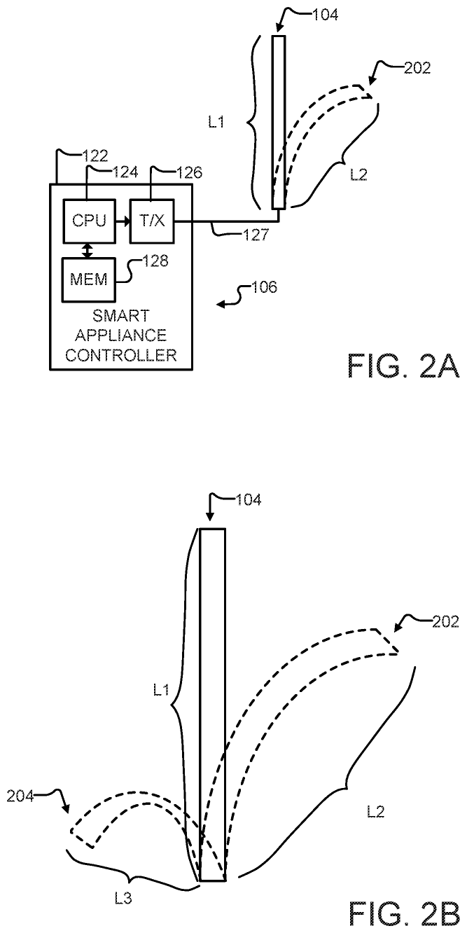

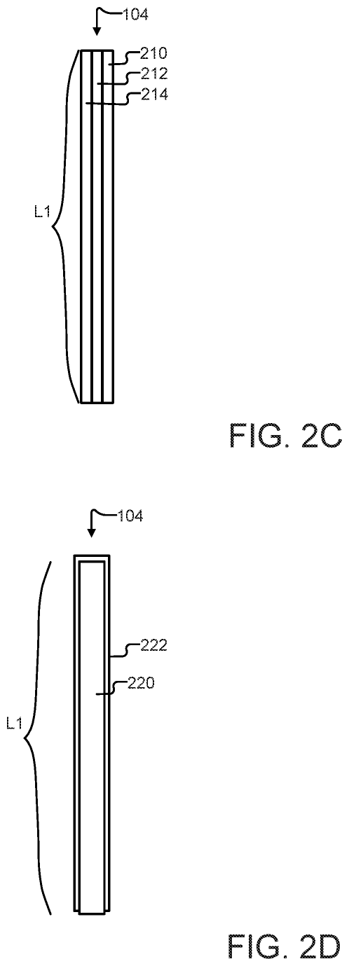

As described above, the antenna 104 may be in operative electrical communication with the smart appliance controller 106 and communication circuit 126. According to example aspects of the present disclosure, the antenna includes a length of memory metal. Furthermore, one end of the length of memory metal may be fused, welded, or soldered to a terminal connection on the smart appliance controller 106 or communication circuit 126. According to one implementation, a cap of a dissimilar metal such as copper or bronze, may be affixed to the one end of the length of memory metal and the cap may then be soldered to a terminal connection or metal trace. According to other implementations, one end of the length of memory metal may be mechanically affixed to a terminal connection, for example, through use of a clamp, screw, or pressure-fitting connection. Other types of connections enabling electrical communication between the high performance antenna and the communication circuit 126 may also be applicable, depending upon a variety of circumstances. Accordingly, all such connections are intended to be within the scope of this disclosure. Furthermore, the antenna 104 may be arranged in any suitable orientation about the communication circuit 126. As illustrated, the antenna 104 may be arranged to “hang” or “substantially freely hang” from the communication circuit 126. Other orientations and arrangements may also be applicable. Hereinafter, a more detailed discussion of the high performance antenna 104 is provided with reference to FIGS. 2A and 2B.

FIG. 2A illustrates a schematic of the smart appliance controller 106 with antenna 104 according to example embodiments of the present disclosure. As illustrated, the antenna 104 includes a first length L1 of memory metal. Although not particularly illustrated, it should be readily understood that two or more lengths of memory metal may also be included without departing from the scope of this disclosure.

The length of memory metal may be chosen to be of sufficient length to enable communication over a wireless communication protocol. Accordingly, the length L1 may be varied depending upon a desired installation environment, communications range considerations, and other considerations. According to at least one implementation, the length L1 is suitable for communication over gigahertz wireless communication protocols. According to another implementation, the length L1 is suitable for 802.11 wireless communication protocols. According to another implementation, the length L1 is suitable for other wireless communication protocols.

As briefly described above, the memory metal, and therefore the antenna 104, are deformable. For example, the antenna may deform from the length L1 to the length L2 while under external stress. In this regard, the memory metal may comprise a deformable metal alloy. One suitable alloy may include an alloy of titanium and nickel. One particular alloy of titanium and nickel may be nitinol.

Upon selection of a suitable alloy and length L1, the diameter of the memory metal may be chosen to be between about 0.05 and 0.15 millimeters. According to one particular implementation, the diameter of the memory metal may be about 0.09 millimeters. As used herein, the use of the term “about” in conjunction with a numerical value refers to within 20% of the stated amount.

As described above with reference to FIG. 1, one end of the length of memory metal may be soldered or welded to a portion of the communication circuit 126. Suitable welding and soldering techniques exist that take into consideration increased or decreased conductivity and formation of metal-to-metal junctions. Accordingly, the length L1 can be lengthened or shortened to compensate for any variations in conductivity due to application of the one end to the communication circuit 126. In some embodiments, the antenna 104 may be in communication with the communication circuit 126 over a transmission line.

FIGS. 2B, 2C, and 2D illustrate a more detailed view of the antenna 104 configured to be used with a smart appliance, such as water heater, in accordance with aspects of the present subject matter. As shown, the antenna 104, and the memory metal comprising the same, may be deformed while under stress to lengths L2 or L3. Upon release of the external stress, the antenna 104 may return to or nearly to the length and shape L1.

Turning to FIG. 2C, the antenna 104 may comprise two or more lengths of memory metal 210, 212, 214. These lengths may form a stranded arrangement as illustrated. Alternatively, they may also be arranged in serial, or end-to-end (not illustrated).

Turning to FIG. 2D, and considering the deformable nature of the antenna 104, a variety of coatings 222 may be used to coat the antenna while maintaining the deformation characteristics described. For example, the antenna 104 may be coated or may be left uncoated. If coated, the coating 222 may include an elastomeric coating, a non-conductive paint coating, a conductive paint coating, or any other suitable coating on the memory metal 220 that allows for deformation and function of the antenna 104.

As described above, antennas may be configured to be used with smart appliances, such as water heaters, and other appliances. The antenna may be used to transmit and receive information and data related to the operation of an appliance over a wireless communication protocol. The data may be processed with a smart appliance controller or other controller. Hereinafter various computer hardware, processors, and associated components capable of performing the above methods are described in detail.

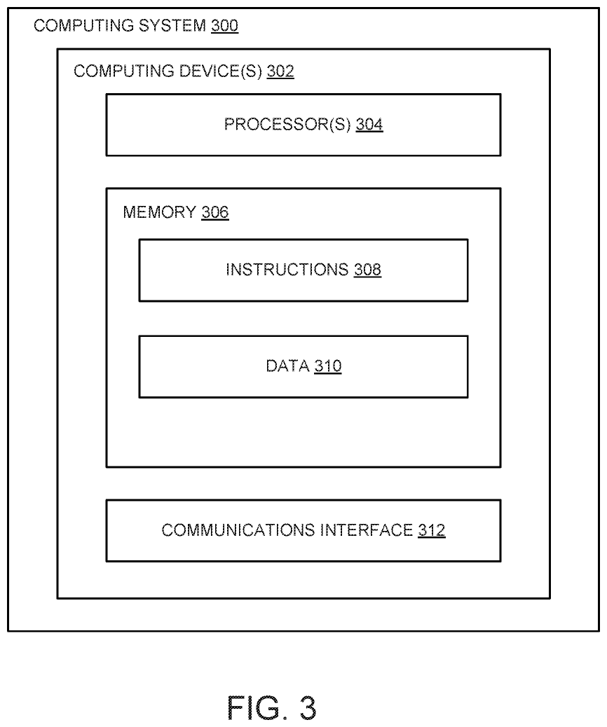

FIG. 3 depicts a block diagram of an example computing system 300 that can be used to implement one or more components of the system 100 or other systems according to example embodiments of the present disclosure. As shown, the computing system 300 can include one or more computing device(s) 302. The one or more computing device(s) 302 can include one or more processor(s) 304 and one or more memory device(s) 306. The one or more processor(s) 304 can include any suitable processing device, such as a microprocessor, microcontroller, integrated circuit, logic device, or other suitable processing device. The one or more memory device(s) 306 can include one or more computer-readable media, including, but not limited to, non-transitory computer-readable media, RAM, ROM, hard drives, flash drives, or other memory devices.

The one or more memory device(s) 306 can store information accessible by the one or more processor(s) 304, including computer-readable instructions 308 that can be executed by the one or more processor(s) 304. The instructions 308 can be any set of instructions that when executed by the one or more processor(s) 304, cause the one or more processor(s) 304 to perform operations. The instructions 308 can be software written in any suitable programming language or can be implemented in hardware. In some embodiments, the instructions 308 can be executed by the one or more processor(s) 304 to cause the one or more processor(s) 304 to perform operations, such as the operations for transmitting information and data with a high performance antenna.

The memory device(s) 306 can further store data 310 that can be accessed by the processors 304. For example, the data 310 can include data related to operation of an appliance or a smart appliance, such as a water heater. The data 610 can include one or more table(s), function(s), algorithm(s), model(s), equation(s), etc. for processing the data according to example embodiments of the present disclosure.

The one or more computing device(s) 302 can also include a communication interface 312 used to communicate, for example, with the other components of the system and/or other computing devices. The communication interface 312 can include any suitable components for interfacing with one or more network(s), including for example, transmitters, receivers, ports, controllers, antennas, or other suitable components.

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

While the present subject matter has been described in detail with respect to specific example embodiments thereof, it will be appreciated that those skilled in the art, upon attaining an understanding of the foregoing may readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. An antenna for use with a smart controller for an appliance, comprising:
a length of memory metal, wherein the antenna is configured to maintain the length while undisturbed, deform while under external stress, and return to or near to the length after deformation; and
wherein one end of the length of memory metal is in operative communication with a communication circuit associated with the smart controller.

2. The antenna of claim 1, further comprising two or more lengths of memory metal.

3. The antenna of claim 1, wherein the length of memory metal is formed from an alloy of titanium and nickel.

4. The antenna of claim 3, wherein the alloy is nitinol.

5. The antenna of claim 1, wherein the length of memory metal has a diameter of between about 0.05 and about 0.15 millimeters.

6. The antenna of claim 5, wherein the length of memory metal has a diameter of about 0.09 millimeters.

7. The antenna of claim 1, wherein the one end of the length of memory metal is soldered or welded to a portion of the communication circuit.

8. The antenna of claim 1, wherein the antenna is in communication with communication circuit via a transmission line.

9. The antenna of claim 1, further comprising a coating on the length of memory metal.

10. The antenna of claim 9, wherein the coating comprises an elastomeric coating.

11. The antenna of claim 9, wherein the coating is a non-conductive paint coating.

12. A smart appliance controller associated with a water heating appliance, comprising:
one or more processors;
one or more memory devices;
a communication circuit;
an antenna in operative communication with the communication circuit, the antenna comprising of a length of memory metal, the memory metal comprising an alloy of alloy of titanium and nickel.

13. The smart appliance controller of claim 12, wherein the alloy is nitinol.

14. The smart appliance controller of claim 12, wherein the length of memory metal has a diameter of between about 0.05 and about 0.15 millimeters.

15. The smart appliance controller of claim 14, wherein the length of memory metal has a diameter of about 0.09 millimeters.

16. The antenna of claim 12, further comprising a coating on the length of memory metal.

17. An antenna for use with a smart controller for a water heating appliance, comprising a length of memory metal, the memory metal comprising an alloy of titanium and nickel, wherein the antenna is configured to be placed operative communication with a communication circuit associated with the smart controller.

18. The antenna of claim 17, wherein the alloy is nitinol.

19. The antenna of claim 17, further comprising a coating on the length of memory metal.

20. The antenna of claim 19, wherein the coating comprises an elastomeric coating.
